(19) United States
(12) Patent Application Publication
(10) Pub. No.: US 2022/0269744 A1
(43) Pub. Date: Aug. 25, 2022

(54) METHODS AND SYSTEMS FOR ENABLING DYNAMIC FILTERS FOR SOFTWARE SEARCH OPTIMIZATION

(71) Applicant: Open Weaver Inc., Miami, FL (US)

(72) Inventors: Ashok Balasubramanian, Chennai (IN); Karthikeyan Krishnaswamy Raja, Chennai (IN); Arul Reagan S, Chengalpattu District (IN); Suresh Babu Konduru, Chennai (IN); John Hansel, Chennai (IN)

(73) Assignee: Open Weaver Inc., Miami, FL (US)

(21) Appl. No.: 17/678,912

(22) Filed: Feb. 23, 2022

Related U.S. Application Data
(60) Provisional application No. 63/153,202, filed on Feb. 24, 2021.

(51) Int. Cl. G06F 16/9535; G06F 16/9536; G06F 16/9538; G06F 16/951

(52) U.S. Cl. CPC G06F 16/9535; G06F 16/9536; G06F 16/9538; G06F 16/951

(57) ABSTRACT

Methods and systems for enabling dynamic filters for software search optimization are disclosed. In one aspect, a method includes receiving a search request, user requirements, and the user preferences from the search system, computing one or more filters from a list comprising a programming language filter, a software component license filter, a software component sources filter, a software component support provided filter, a software component type filter, an industry domain filter choices, and a software component security filter, generating a filter widget based on the one or more computed filters, and applying the filter widget crawling internet sources to provide search results.

### CROSS-REFERENCE TO RELATED PATENT APPLICATION

This application claims the benefit of and priority to U.S. Provisional Patent Application No. 63/153,202 filed Feb. 24, 2021, the entire disclosure of which is incorporated by reference herein.

### TECHNICAL FIELD

The present disclosure relates to methods and systems for filtering of software components based on their attributes across multiple dimensions and user preferences and configured to be used in conjunction with a search engine for software components.

### BACKGROUND

With open-source technologies, cloud based public code repositories and cloud based applications increasing exponentially, there is a need for software developers to have a way to find such software components for use in their software development. Today there are more than 30 million public code repositories and 100,000 public application programming interface (APIs). There are few 100 million articles that provide knowledge and reviews of the software components.

Even with a dedicated software search engine that produces a search similarity score, the developer needs to sort through hundreds of thousands of results to identify a software component that is fit for a user.

Typically, a software developer has specific architecture requirements. She also has preferences on the licensing terms based on the scope of work. She might also look for better supported software components to avoid rework. She might prefer secure components from specific providers and related to user's industry domain.

Trying to define all of these requirements in a single search query along with the actual function that she is looking for is not possible without significantly impacting the search results.

Korean Patent Application Publication No. 10-2020-0062917A titled “Open Source Software Recommendation System and Method Using Personal Profiling” discloses an open source software recommendation system and a method thereof which combine user profiling and keyword search to efficiently search for open source software to provide a user who intends to use open source software with a difficult concept of license to be easily understood, promote license selection convenience, and recommend corresponding reliable open source software. However, this disclosure deals with recommending software for a user, not deals with recommending dynamic filters using machine learning based approach, and emphasize more on filtering aspect of search and not on search.

However, the above document and conventional techniques existed at the time of this disclosure does not teach defining the various user requirements in a single search query without significantly impacting the search results.

Therefore, there is a need for an improved method for providing dynamic filters to find software libraries in a software project repository.

### SUMMARY

The following presents a simplified summary in order to provide a basic understanding of some aspects of the disclosed technology. This summary is not an extensive overview, and it is not intended to identify key/critical elements or to delineate the scope thereof. Its sole purpose is to present some concepts in a simplified form as a prelude to the more detailed description that is presented later. The subject matter should be understood by reference to appropriate portions of the entire specification of this patent, any or all drawings, and each claim.

The disclosure provides an improved method, system, and computer program product for providing dynamic filters to find software libraries in a software project repository. The present disclosure uses a machine learning based software component filtering solution that will provide a set of dynamic filters that will augment a search engine and return specific search results for a developer based on their specific needs. The machine learning model used here is a recommendation engine. The parameters to recommendation engine vary based on a user. Assuming there are two kinds of users like logged-in users and new users. The parameters considered as input to the recommendation engine for logged-in users are language, technology area, user preferences, language, license, source, support, component type, security, and industry domain. For new users, the parameters considered as input to the recommendation engine are search query, search history, historical query data and recommendation based on the above three parameters.

User preferences are collected for signed up/New users. The process of collecting user preferences involves preference data from user explicitly, store data based on filters selected by users, store data based on results selected by users, identifying filter attributes from search query, parse search query, extract filter attributes and using search query with filter attributes to search in indexes.

Implementations of the subject matter described in this specification can be implemented to realize one or more of the following advantages. The above disclosed system and method helps for user with user preferences captured are displayed with the filter dynamically by identifying from user preference and user's interest apart from what a user has provided in search query, recommend the additional filter items in the top as per user's interest.

The above disclosed method and system also helps a user without user preferences captured and new users are displayed with the filter dynamically by identifying like-minded users filter selection and interest based on search query and recommend the filter items based on recommendation engine.

That is, the above disclosed method and system will help developers simplify and save considerable time in searching libraries with compliance to user requirements, thereby elevating user experience, reducing rework, and improving quality and productivity.

The disclosed method and system enables dynamic filters for software search in an open-source project repository. The filters that are enabled are, but not limited to, Language filter, License filter, Source filter, Support filter, Component filter, Security filter and Industry filter. These filters provide data for displaying on the filter widget. The recommendation engine and constant like High, Medium, Low determine the count on the list of filters that are loaded dynamically to enable software search optimization.

The foregoing, together with other features and embodiments, will become more apparent upon referring to the following specification, claims, and accompanying drawings.

An aspect includes a system for enabling dynamic filters for software search optimization comprising: one or more processors and memory storing instructions that, when executed by the one or more processors, cause the one or more processors to perform operations comprising: receiving a search request, user requirements, and the user preferences from the search system; computing one or more filters from a list comprising a programming language filter, a software component license filter, a software component sources filter, a software component support provided filter, a software component type filter, an industry domain filter choices, and a software component security filter; generating a filter widget based on the one or more computed filters; and applying the filter widget crawling interne sources to provide search results.

In some embodiments, the operations further comprises: processing the search request, the filter requirements, and the user preferences from a search system; associating the search request with different filter types to decide which filter templates to apply in addition to the filter requirements from the search system; processing the user preferences from selection by the user or from past usage or from other users processing similar queries or a combination of all; and determining a layout type and filter parameters for the filter widget, the layout type including one of a simple mode, an expanded mode, or a collapsed mode, wherein the filter parameters include one or more of programming language, license, software sources, software component support, software component type, industries and domains, or security of the software component.

In some embodiments, the operations further comprises: receiving the layout type; determining, based on the layout type, whether to include one or more filters in the filter widget; and collating the filter parameters from the one or more filters in the requested filter layout format.

In some embodiments, the operations further comprises: providing, based on results of a machine learning algorithm, a predetermined number of the most relevant set of programming languages as filters related to the user search; providing frameworks and technologies that are most relevant to the topic identified in the user search; and sorting the most relevant set of programming languages based on the user preference or user behavior, according to the most frequently selected technologies by the user.

In some embodiments, the operations further comprises: providing, based on results of a machine learning algorithm, a predetermined number of the most relevant set of licenses as filters related to the user search; processing one or more license types including open source, proprietary licenses, or cloud software; and sorting based on the user preference or user behavior, according to the licenses that they most frequently select.

In some embodiments, the operations further comprises: providing, based on results of a machine learning algorithm, a predetermined number of the most relevant set of sources as filters related to the user search; processing one or more sources including open-source repositories, proprietary software providers, or cloud providers; and sorting based on the user preference or user behavior, according to the sources that they most frequently select.

In some embodiments, the operations further comprises: providing a gradient selection of support services provided by the relevant software component providers; assigning weights to internal metrics including one or more of issue fix rate, number of bugs open, or reviews from the internet for selection of support level; displaying a plurality of choices including high, medium, and low based on the weighted internal metrics; and pre-selecting based on the user preference or user behavior, according to the support category that they most frequently select.

In some embodiments, the operations further comprises: providing, based on results of a machine learning algorithm, a predetermined number of the most relevant set of component types as filters related to the user search; processing one or more component types including one or more of open-source repositories, proprietary software providers, or cloud providers; and sorting based on the user preference or user behavior, according to the component types that they most frequently select.

In some embodiments, the operations further comprises: providing, based on results of a machine learning algorithm, a predetermined number of the most relevant set of domains and industries as filters related to the user search, wherein the domains and industries include one or more of manufacturing, utilities, travel and transportation, retail, telecommunications and media, healthcare, financial services, government and institutions, artificial intelligence, blockchain, augmented reality, virtual reality, internet of things (IoT), big data, 3D printing, edge computing, robotics, autonomous navigation, biometrics, quantum computing, database, networking, security, messaging, DevOps, cloud computing, monitoring, serverless computing, integration, web servers, automation, testing, business process management (BPM), or data visualization; and sorting based on the user preference or user behavior, according to the industries that they most frequently select.

In some embodiments, the operations further comprises: providing a gradient selection of security associated with the relevant software components; assigning weights to internal metrics including one or more of vulnerabilities reported, number of bugs open, or reviews from the internet for selection of security level; displaying choices including High, Medium, and Low, based on the user's internal metrics; and pre-selecting based on the user preference or user behavior, according to the security category that they most frequently select.

In some embodiments, the operations further comprises: converting the one or more filters into a layout format, wherein the format comprises messages including one or more of JSON, XML or fully usable UI components on a user device.

In some embodiments, the operations further comprises: accessing the internet sources including one or more of public repositories, cloud providers, Q&A, review sites, or vulnerability databases; receiving information, based on the accessed internet sources, on programming language, licenses, sources, support, component types, industry domains and security information; and parsing and storing received information into the File Storage.

Another aspect is a method of enabling dynamic filters for software search optimization comprising: receiving a search request, user requirements, and the user preferences from the search system; computing one or more filters from a list comprising a programming language filter, a software component license filter, a software component sources filter, a software component support provided filter, a software component type filter, an industry domain filter choices, and a software component security filter; generating a filter widget based on the one or more computed filters; and applying the filter widget crawling internet sources to provide search results.

In some embodiments, the method further comprises: associating the search request with different filter types to decide which filter templates to apply in addition to the filter requirements from the search system.

In some embodiments, the method further comprises: processing the user preferences from selection by the user or from past usage or from other users processing similar queries or a combination of all.

In some embodiments, the method further comprises: determining a layout type and filter parameters for the filter widget, the layout type including one of a simple mode, an expanded mode, or a collapsed mode, wherein the filter parameters include one or more of programming language, license, software sources, software component support, software component type, industries, or security of the software component.

In some embodiments, the method further comprises: receiving the layout type; and determining, based on the layout type, whether to include one or more filters in the filter widget.

In some embodiments, the method further comprises: providing, based on results of a machine learning algorithm, a predetermined number the most relevant set of programming languages as filters related to the user search including frameworks and technologies that are most relevant to the topic identified in the user search; and sorting the most relevant set of programming languages based on the user preference or the user behavior, according to the technologies that the user most frequently selects.

In some embodiments, the method further comprises: providing, based on results of a machine learning algorithm, a predetermined number of the most relevant set of licenses as filters related to the user search including one or more of open source, proprietary licenses, or cloud software; and sorting based on the user preference or the user behavior, according to the licenses that they most frequently select.

Another aspect is a computer program product for enabling dynamic filters for software search optimization comprising a processor and memory storing instructions thereon, wherein the instructions when executed by the processor cause the processor to perform operations comprising: receiving a search request, user requirements, and the user preferences from the search system; computing one or more filters from a list comprising a programming language filter, a software component license filter, a software component sources filter, a software component support provided filter, a software component type filter, an industry domain filter choices, and a software component security filter; generating a filter widget based on the one or more computed filters; and applying the filter widget crawling internet sources to provide search results.

### BRIEF DESCRIPTION OF THE DRAWINGS

FIG. 1 shows a system architecture that performs enabling of dynamic filters for software search optimization, according to some embodiments.

FIG. 2 shows an example computer system implementation for enabling dynamic filters for software search optimization, according to some embodiments.

FIG. 3 shows the overall process flow of enabling dynamic filters for software search optimization, according to some embodiments.

FIG. 4 shows an example of implementation of the dynamic filter widget with most common choices, according to some embodiments.

FIG. 5 shows an example of implementation of the dynamic filter widget with increased set of choices, according to some embodiments.

FIG. 6 shows an example of implementation of the dynamic filter widget that can show the user preferences implemented in the filter, according to some embodiments.

FIG. 7 shows the implementation of the Language filter that can show the user preferences and process flow implemented in the filter, according to some embodiments.

FIG. 8 shows the implementation of the License filter that can show the user preferences and process flow implemented in the filter, according to some embodiments.

FIG. 9 shows the implementation of the Source filter that can show the user preferences and process flow implemented to the filter, according to some embodiments.

FIG. 10 shows the implementation of the Support filter that can show the user preferences and process flow implemented in the filter, according to some embodiments.

FIG. 11 shows the implementation of the Component type (Cloud Functions, API, Libraries, Source code etc.) filter that can show the user preferences and process flow implemented to the filter, according to some embodiments.

FIG. 12 shows the implementation of the industry (Financial sector, Agriculture, Government, Healthcare, Manufacturing, Retail, Telecommunication, Media, Transportation, Information technology, Robotics, etc.) filter that can show the user preferences and process flow implemented to the filter, according to some embodiments.

FIG. 13 shows the implementation of the Security filter that can show the user preferences and process flow implemented to the filter, according to some embodiments.

FIG. 14 shows a process that can be performed by a computer program product for enabling dynamic filter for software search optimization, according to some embodiments.

Like reference numbers and designations in the various drawings indicate like elements.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the disclosed technology. However, it will be apparent that various embodiments may be practiced without these specific details. The figures and description are not intended to be restrictive.

The ensuing description provides examples only, and is not intended to limit the scope, applicability, or configuration of the disclosure. Rather, the ensuing description of various examples will provide those skilled in the art with an enabling description for implementing any of the examples. It should be understood that various changes may be made in the function and arrangement of elements without departing from the scope of the disclosure as set forth in the appended claims.

The present disclosure includes a machine learning based software component filtering solution which will be based on a recommendation engine that will provide a set of dynamic filters that will augment a search engine and provide specific search results for a developer based on their specific needs.

The disclosed method and system may help the developer to save significant effort and provide automated compliance to the user requirements, thereby eliminating rework and improving quality and productivity.

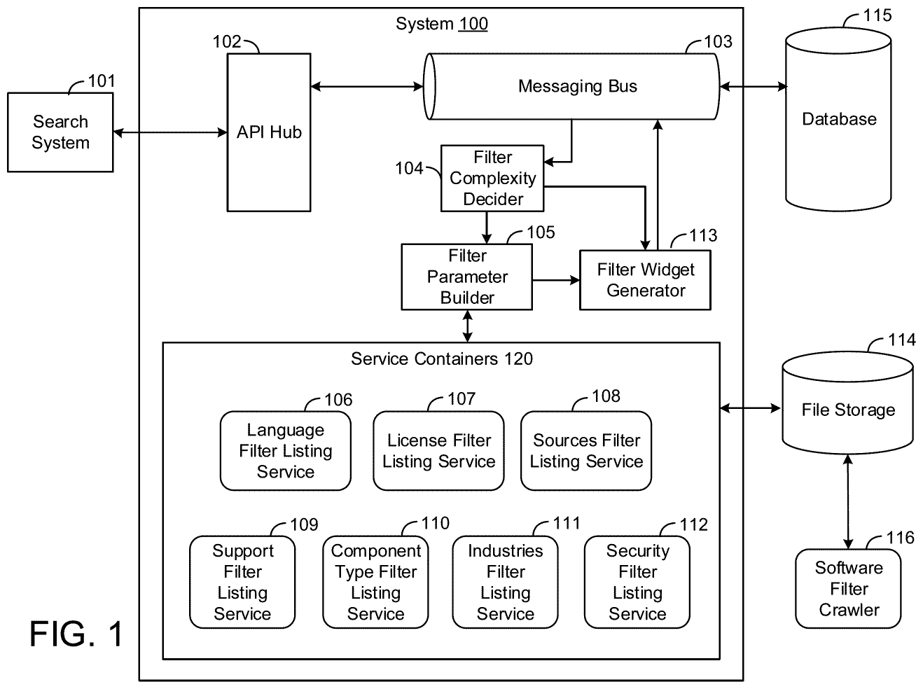

FIG. 1 shows a system 100 or a high-level architecture that does enabling of dynamic filters for software search optimization, in accordance with some embodiments. Briefly, and as described in further detail below, the system 100 includes an API Hub 102, Messaging Bus 103, Filter Complexity Decider 104, and Filter Parameter Builder 105. The system 100 includes Service Containers 120 which include Language Filter Listing Service 106, License Filter Listing Service 107, Sources Filter Listing Service 108, Support Filter Listing Service 109, Component Type Filter Listing Service 110, Industries Filter Listing Service 111, and Security Filter Listing Service 112. The system further includes or is connected to Filter Widget Generator 113, File Storage 114, Database 115, Software Filter Crawler 116, and Search System 101, which are a unique set of components to perform the task of enabling dynamic filters for software search optimization given search requirements and user preferences from the search system. The Service Containers 120 may include additional services that are not shown in FIG. 1.

In the embodiment shown in FIG. 1, the Search System 101 captures and transmits the search request, filter needs and the user preferences. Post processing of the request, the Search System 101 will incorporate and display the filter widget that it receives.

The request from Search System 101 goes to the API hub 102 which acts as a gateway for accepting and transmitting all web service requests. The API hub 102 hosts the web services for taking the requests and creating request messages to be put into the Messaging Bus 103. The Messaging Bus 103 provides for event driven architecture thereby enabling long running processes to be decoupled from requesting system's calls. This decoupling will help the system to service the request and notify calling system once the entire process of generating the filter is completed. There are job listeners (not shown in figure) configured to listen to the messages in the Messaging Bus 103.

The Filter Complexity Decider 104 decides on the type of filter complexity and template based on the search request, type of filter required and user preferences. User preferences can be explicit choices or can be machine learnt based on user behavior of that user or a set of users using filters in related searches. The Filter Complexity Decider 104 will decide on layout such as but not limited to simple, expanded, collapsed as well as the filter parameters that need to be used for the filter widget such as but not limited to programming language, license, software sources, software component support, software component type, industries and domains, and security of that software component.

The Filter Parameter Builder 105 is an anchor that coordinates with different services such as Language Filter Listing Service 106, License Filter Listing Service 107, Sources Filter Listing Service 108, Support Filter Listing Service 109, Component Type Filter Listing Service 110, Industries Filter Listing Service 111, Security Filter Listing Service 112 to collate the filters to be created in the filter widget. It calls the different services based on the type of filters that need to be used for the current user search.

The Language Filter Listing Service 106 leverages machine learning technologies to provide the most relevant set of programming languages as filters related to the user search. This covers frameworks, technologies that are most relevant to the topic identified in the user search. It is also sorted based on the user preference shared or based on this user or other user behavior, according to the technologies that they most frequently select.

The License Filter Listing Service 107 leverages machine learning technologies to provide the most relevant set of licenses as filters related to the user search. For example, when the user is looking for open-source software it displays the type of open-source licenses and when they are searching for cloud software components, it shows SaaS licenses. It is also sorted based on the user preference shared or based on this user or other user behavior, according to the license that they most frequently select.

The Sources Filter Listing Service 108 leverages machine learning technologies to provide the most relevant set of sources as filters related to the user search. For example, when the user is looking for open-source software, it displays open-source repositories and when they are searching for cloud software components, it shows the list of available cloud providers in that period. The period can be days, weeks, months, or years. It is also sorted based on the user preference shared or based on this user or other user behavior, according to the sources that they most frequently select.

The Support Filter Listing Service 109 provides a gradient selection of support services provided by the relevant software component providers. While the filter widget could display choices such as High, Medium, Low, the filter user's internal metrics such as, but not limited to issue fix rate, number of bugs open, reviews from the internet to assign weights to the selection. It is also pre-selected based on the user preference shared or based on this user or other user behavior, according to the support category that they most frequently select.

The Component Type Filter Listing Service 110 leverages machine learning technologies to provide the most relevant set of component types as filters related to the user search. For example, when the user is looking for open-source software it displays libraries, source code and when they are searching for cloud software components it shows as a service models. It is also sorted based on the user preference shared or based on this user or other user behavior, according to the component types that they most frequently select.

The Industries Filter Listing Service 111 leverages machine learning technologies to provide the most relevant set of industries and domains as filters related to the user search. For example, when the user is looking for financial services components, it displays fintech, payments and other related filters and when they are searching for patient management components it shows health care providers, health insurance, hospital management domain filters. It is also sorted based on the user preference shared or based on this user or other user behavior, according to the industries that they most frequently select.

The Security Filter Listing Service 112 provides a gradient selection of security associated with the relevant software components. While the filter widget could display choices such as High, Medium, Low, the filter user's internal metrics such as, but not limited to vulnerabilities reported, number of bugs open, reviews from the internet to assign weights to the selection. It is also pre-selected based on the user preference shared or based on this user or other user behavior, according to the security category that they most frequently select.

The Filter Widget Generator 113 takes the consolidated filter parameters from the different filter component services that have been processed by the Filter Parameter Builder 105 and converts it to the format required by the Search System 101. These formats are, but not limited to messages such as JSON, XML or fully usable UI components across the computer, tablet, mobile screens in a responsive technology such as React.

The File Storage 114 is used to store document type of data, source code files, documents, readme files, installation guides, user guides, neural network models etc.

The Database 115 is RDBS database like MySQL to store all meta-data pertaining to the requests received from the search system, messaging bus, request processor and from other system components described above. The meta-data includes details of every request to identify who submitted it, requested details to track the progress as the System processes the request through its different tasks. The status of each execution step in entire process is stored in this database to track and notify the system on completion.

The Software Filter Crawler 116 crawls the internet sources such as, but not limited to public repositories, cloud providers, Q&A, review sites, vulnerability databases to parse and store information on programming language, licenses, sources, support, component types, industry domains and security information of the various software libraries and/or projects into the File Storage 114.

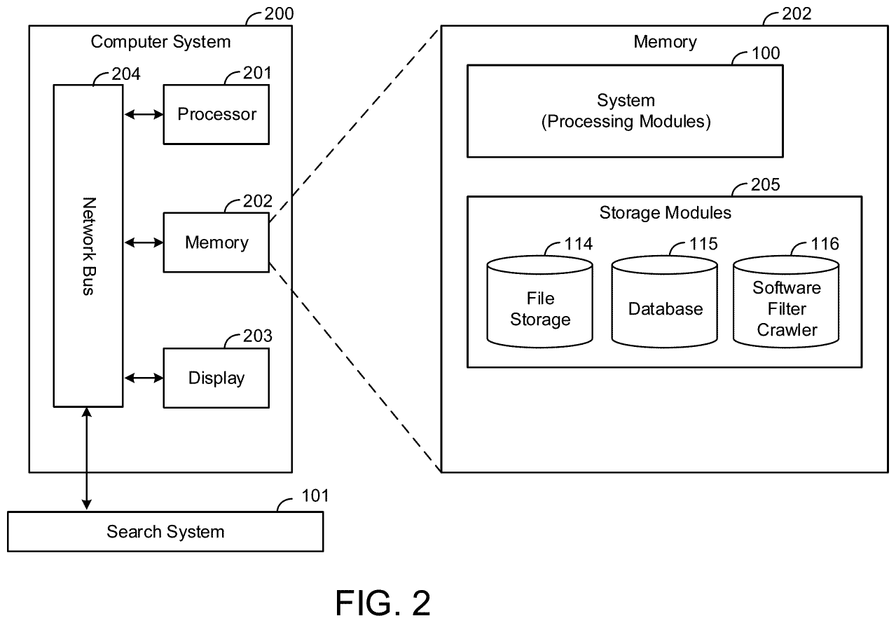

FIG. 2 shows a block view of the computer system 200 of enabling dynamic filters for software search optimization, in accordance with some embodiments. This may include a Processor 201, Memory 202, Display 203, Network Bus 204, and other input/output like a mic, speaker, wireless card etc. The processing modules of the System 100, File Storage 114, Database 115, Software Filter Crawler 116, are stored in the Memory 202 which provides the necessary machine instructions to the Processor 201 to perform the executions for enabling dynamic filters for software search optimization. In some embodiments, the Processor 201 controls the overall operation of the system and managing the communication between the components through the Network Bus 204. The Memory 202 holds the enabling dynamic filters for software search optimization system code, data, and instructions of the System 100 and of diverse types of the non-volatile memory and volatile memory. The external Search System 101 interacts via the Network Bus 204.

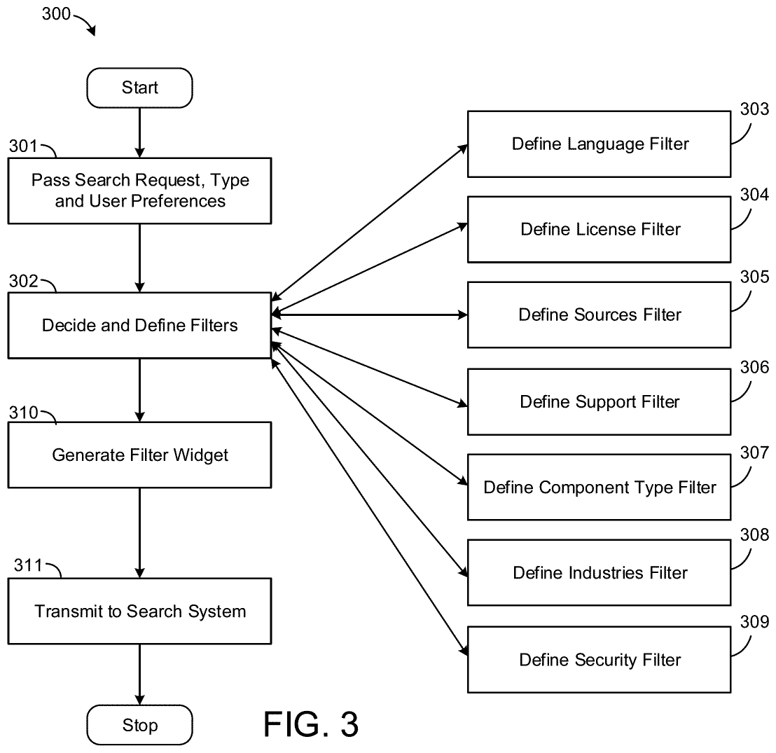

FIG. 3 shows the end-to-end process for enabling dynamic filters for software search optimization, in accordance with some embodiments. In step 301, the search request, filter needs (e.g., type of filter), and the user preferences are captured from the search system and sent (e.g., passed) downstream. In step 302, the filters to be used are decided based on the search request, type of filter required and the user preferences. For example, the popularity rating score is calculated. In step 303, the programming language filter choices are defined and/or computed. In step 304, the software component license filter choices are defined and/or computed. In step 305, the software component sources filter choices are defined and/or computed. In step 306, the software component support provided filter choices are defined and/or computed. In step 307, the software component type filter choices are defined and/or computed. In step 308, the industry domain filter choices are defined and/or computed. In step 309, the software component security filter choices are defined and/or computed. In step 310, the filter widget is generated based on the individual filters computed in above steps (e.g., steps 301-309). In step 311, based on the format requested by the search system, the filter widget is shared (e.g., transmitted) to the search system.

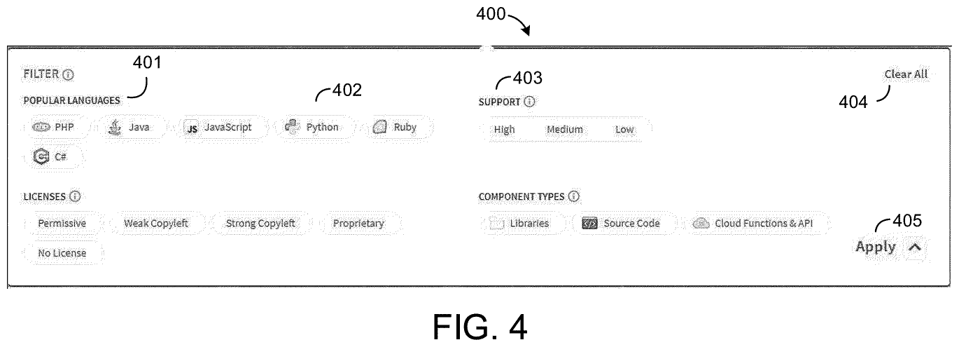

FIG. 4 shows an exemplary Filter Widget 400 that is an implementation based on certain filter needs requested by the Search System 101, in accordance with some embodiments. For example, the Filter Widget 400 may be generated (e.g., step 310) based on the various parameters (e.g., search request, type, and user preferences in step 301). The Filter Widget 400 shows filter categories and choices, and as an example, of programming languages 401 and sample programming language choices 402. The Filter Widget 400 also provides Information Widgets 403. The Clear Function 404 enables a user to reset the filter choices and Apply 405 enables the users to apply the search choices to the search system.

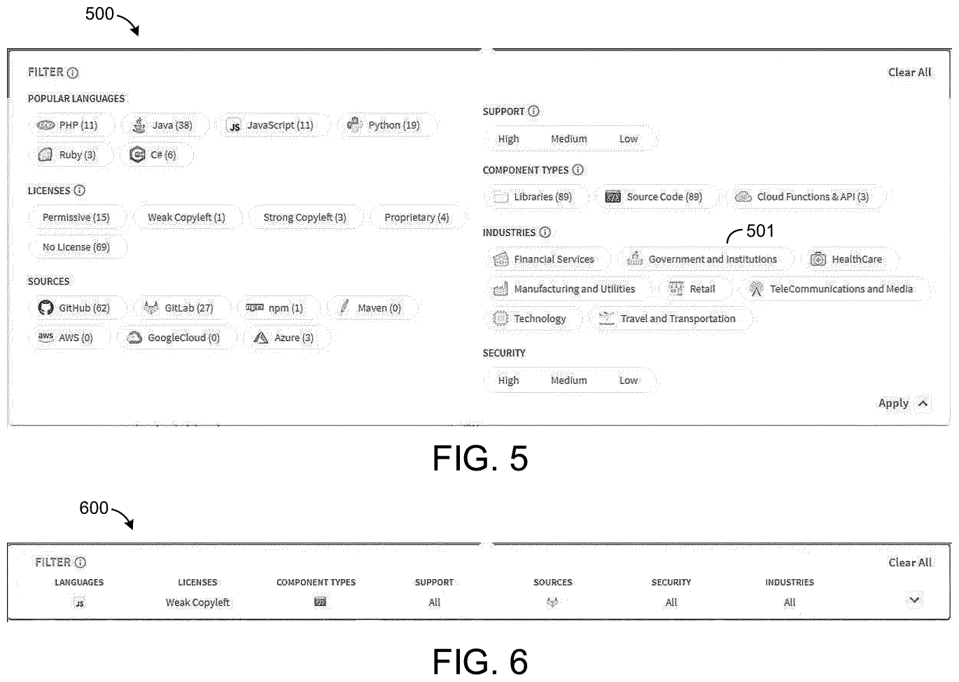

FIG. 5 shows another exemplary Filter Widget 500, in accordance with some embodiments. The Filter Widget 500 is an implementation based on expanded filter needs requested by the Search System 101 and shows additional categories such as Industry Domains 501.

FIG. 6 shows another exemplary Filter Widget 600, in accordance with some embodiments. The Filter Widget 600 is an implementation based on collapsed filter needs requested by the search system 101 and shows the filter selected by the user explicitly or based on their preferences.

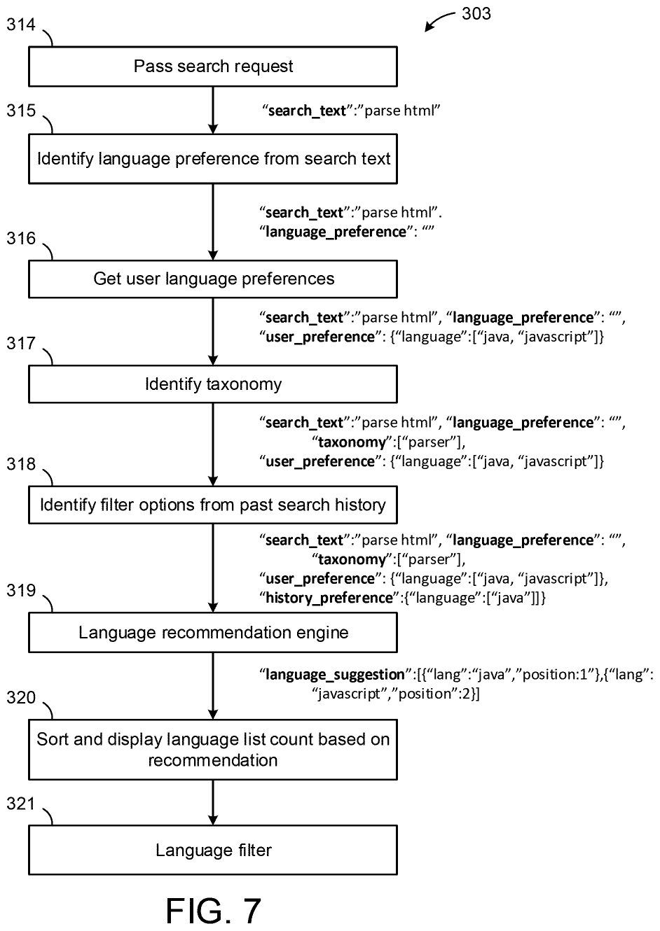

FIG. 7 shows a detailed view of step 303 of defining of a language filter, in accordance with some embodiments. The language filter leverages recommendation engine to provide the most relevant set of programming languages as filters related to the user search. Step (or process) 303 includes a step 314 of passing a search request (e.g., step 301). The process involves identifying language preference in search text (step 315), checking or obtaining or getting language preferences of a logged-in user (step 316), identifying taxonomy of the search text (step 317), and parsing the text and identifying and/or recommending based on the previous search history for new users and existing users (step 318). Parsing the search input text is done by splitting the input text and search configuration along with text search dictionaries to be used for searching. The splitting of search inputs against pre-configured dictionaries are language, search history and user preferences. The system includes a dictionary which is pre-loaded with all the languages available as part of open-source repositories. Language recommendation engine receives these inputs from the search text, user preferences, search history to sort and display the languages list count (step 319). It is sorted based on the user preference shared or based on this user or other user behavior, according to the technologies that are most relevant to the topic identified in the user search (step 320). In step 321, a language filter is defined.

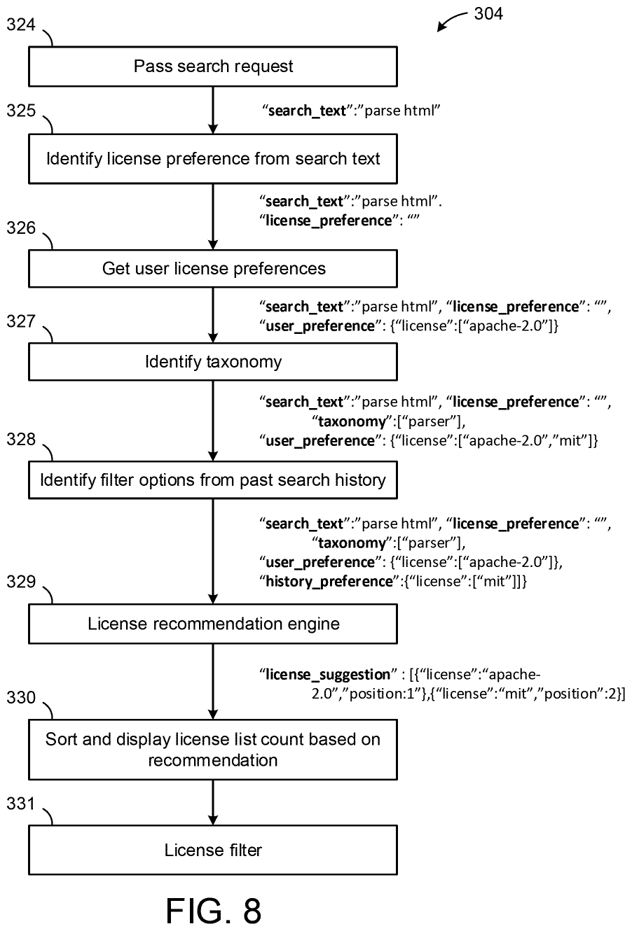

FIG. 8 shows a detailed view of step 304 of defining of license filter, in accordance with some embodiments. The license filter leverages recommendation engine to provide the most relevant set of licenses as filters related to the user search for open-source projects. Step 304 includes a step 324 of passing a search request (e.g., step 301). The process involves identifying license preference in search text (step 325), parsing and identifying license preference from the search input text, check license preferences of a logged-in user (step 326), identifying or getting taxonomy of the search text (step 327) and identifying and/or recommending filter options based on the previous search history for new users and existing users (step 328). Parsing the search input text is done by splitting the input text and search configuration along with text search dictionaries to be used for searching. The splitting of search inputs against pre-configured dictionaries are license, search history and user preferences. The system includes a dictionary which is pre-loaded with all the licenses available as part of open-source repositories. License recommendation engine receives (step 329) these inputs from the search text, licenses preferred by user, search history to sort and display the licenses list count (step 330). It is sorted based on the user preference shared or based on this user or other user behavior, according to the technologies that are most relevant to the topic identified in the user search. In step 331, a license filter is defined.

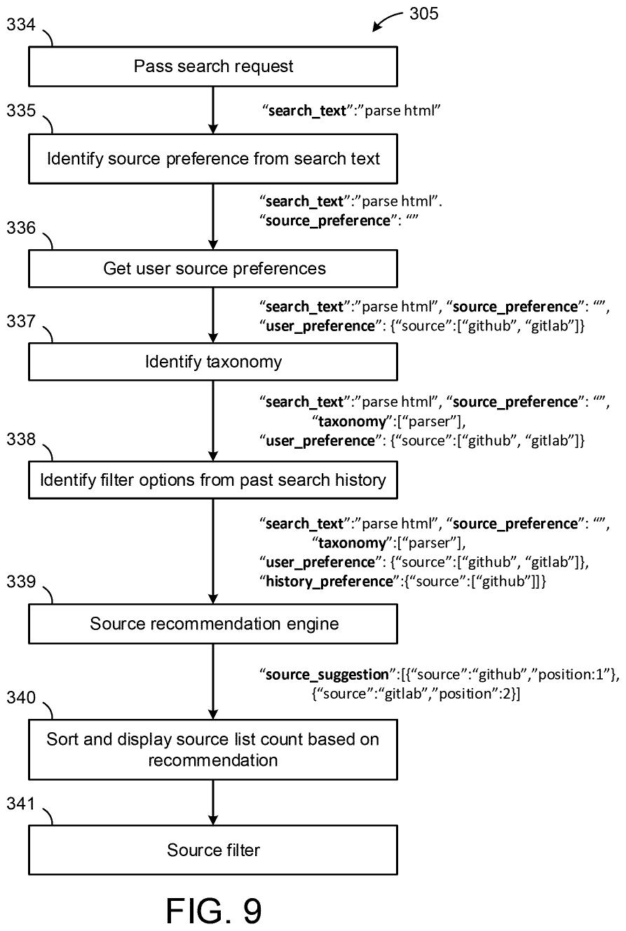

FIG. 9 shows a detailed view of step 305 of defining the source filter, in accordance with some embodiments. The source filter uses recommendation engine to provide the most relevant set of sources as filters related to the user search from the open-source projects that are retrieved from various software repositories. Step 304 includes a step 334 of passing a search request (e.g., step 301). The process involves identifying source preference in search text (step 335), checking and/or getting source preferences of a logged-in user (step 336), parsing the search input text, identifying taxonomy of the search text (step 337) and identifying and/or recommending based on the previous search history for new users and existing users (step 338). Parsing the search input text is done by splitting the input text and search configuration along with text search dictionaries to be used for searching. The splitting of search inputs against pre-configured dictionaries are sources, search history and user preferences. The system includes a dictionary which is pre-loaded with all the sources available as part of open-source repositories. Source recommendation engine receives (step 339) these inputs from the search text, sources preferred by user, search history to sort and display the sources list count (Step 340). It is sorted based on the user preference shared or based on this user or other user behavior, according to the technologies that are most relevant to the topic identified in the user search. In step 341, a source filter is defined.

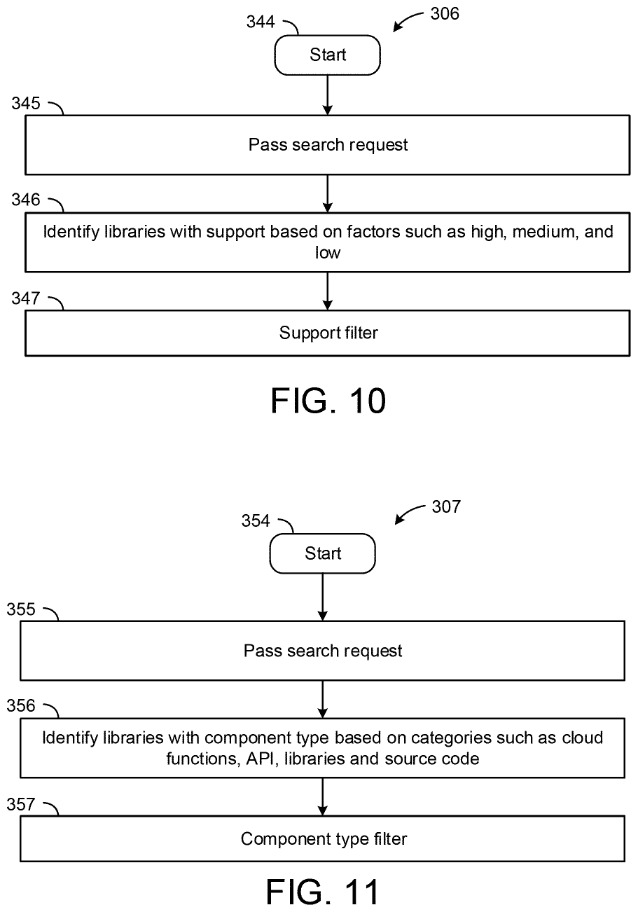

FIG. 10 shows a detailed view of step 306 of defining a support filter, in accordance with some embodiments. Step 306 includes a step 345 of passing a search request (e.g., step 301). The support filter identifies libraries with support based on constants having values as High, Medium, and low (step 346). The process involves identifying and parsing the search text and check support preferences of a logged-in user. Parsing the search input text is done by splitting the input text and search configuration along with text search dictionaries to be used for searching. The splitting of search inputs against pre-configured dictionaries are Support, search history and user preferences. Support filter is displayed with available count of listed libraries. It is sorted based on the user preference shared or based on the support framework available or other user behavior, according to the technologies that are most relevant to the topic identified in the user search. In step 347, a support filter is defined.

FIG. 11 shows a detailed view of step 307 of defining component type filter, in accordance with some embodiments. Step 307 includes a step 354 of passing a search request (e.g., step 301). The component type filter identifies libraries with components based on constants having values for e.g., Cloud functions, API, Libraries, Source code (Step 356). The process involves identifying parsing the search text and check component preferences of a logged-in user. Parsing the search input text is done by splitting the input text and search configuration along with text search dictionaries to be used for searching. The splitting of search inputs against pre-configured dictionaries are component types, search history and user preferences. Component type filter is displayed with count of list of available libraries. It is sorted based on the user preference shared or based on the components available or other user behavior, according to the technologies that are most relevant to the topic identified in the user search. In step 357, a component type filter is defined.

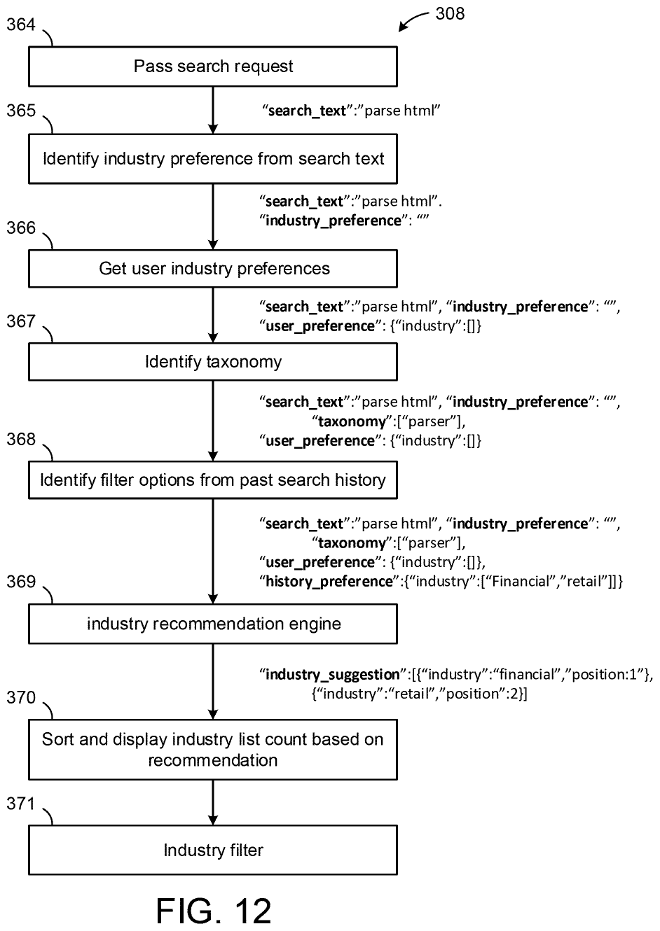

FIG. 12 shows a detailed view of step 308 of defining an industry filter, in accordance with some embodiments. The industry filter uses recommendation engine to provide the most relevant set of industries (Financial sector, Agriculture, Government, Healthcare, Manufacturing, Retail, Telecommunication, Media, Transportation, Information technology, Robotics, etc.) as filters related to the user search from the open-source projects that are retrieved from various software repositories. Step 364 includes a step 314 of passing a search request (e.g., step 301). The process involves identifying industry preference in search text (step 365), checking and/or getting industry preferences of a logged-in user (Step 366), identifying taxonomy of the search text (step 367) and identifying and/or recommending based on the previous search history for new users and existing users (step 368). Parsing the search input text is done by splitting the input text and search configuration along with text search dictionaries to be used for searching. The splitting of search inputs against pre-configured dictionaries are diverse types of industry domains, search history and user preferences. The system includes a dictionary which is pre-loaded with all the diverse types of domains available as part of this technology world. Industry recommendation engine receives these inputs from the search text (step 369), industries preferred by user, search history to sort and display the sources list count (step 370). It is sorted based on the user preference shared or based on this user or other user behavior, according to the technologies that are most relevant to the topic identified in the user search. In step 371, an industry filter is defined.

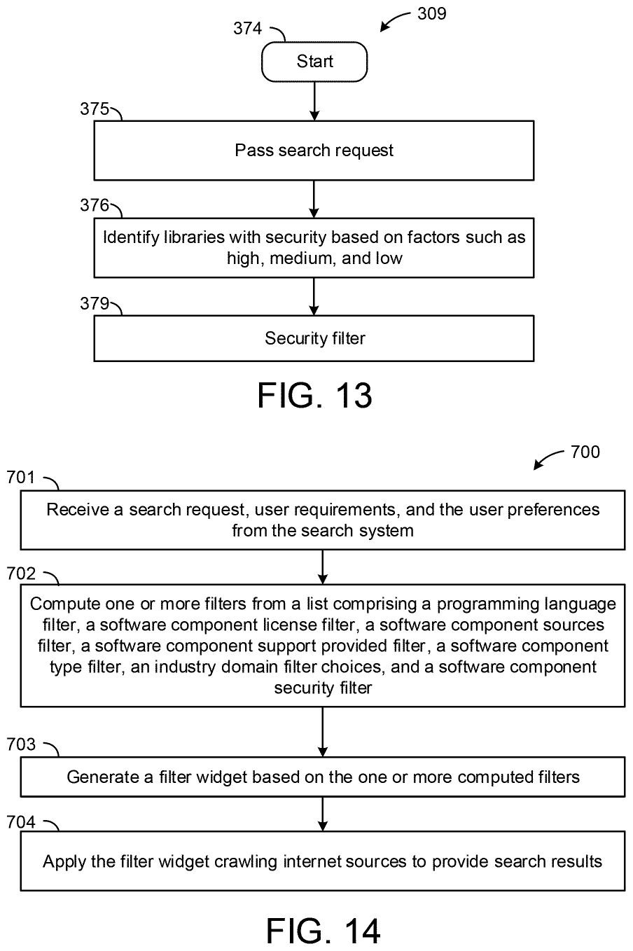

FIG. 13 shows a detailed view of step 309 of identifying a security filter, in accordance with some embodiments. Security filter is a constant having values as High, Medium, and low. The process involves identifying parsing the search text and check security preferences of a logged-in user. Parsing the search input text is done by splitting the input text and search configuration along with text search dictionaries to be used for searching. The splitting of search inputs against pre-configured dictionaries are diverse types of Security, search history and user preferences. Security filters are displayed with available count of listed libraries. It is sorted based on the user preference shared or based on the security framework available or other user behavior, according to the technologies that are most relevant to the topic identified in the user search.

In some embodiments, the process 300 of FIGS. 3 and 7-13 involves identifying the search input text, checking user preferences of a logged-in user, and parsing the search input text by splitting the input text and search configuration along with text search dictionaries to be used for searching. The splitting of search inputs against pre-configured dictionaries of Language, License, Source, Support filter, Component type, Security and Industry domain, search history and user preferences in the system. The filters from the available list of Language filter, License filter, Source filter, Support filter, Component type filter, Security filter and Industry domain filter will be sorted based on the user search, technologies that are most relevant to the topic identified in the user search, recommendations, and user preferences.

FIG. 14 shows a process 700 that can be performed by a computer program product for enabling dynamic filter for software search optimization, in accordance with some embodiments. Process 700 can be performed by one or more components of system 100 as previously described. The computer program product for automated software natural language documentation comprises a processor and memory storing instructions. The instructions when executed by the processor causes the processor to perform multiple steps. receiving a search request, user requirements, and the user preferences from the search system (step 701), computing one or more filters from a list comprising a programming language filter, a software component license filter, a software component sources filter, a software component support provided filter, a software component type filter, an industry domain filter choices, and a software component security filter (step 702), generating a filter widget based on the one or more computed filters (step 703), and applying the filter widget crawling internet sources to provide search results (step 704).

The methods disclosed in this disclosure comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

Certain aspects of this disclosure may comprise a computer program product for performing the operations presented herein. For example, such a computer program product may comprise a computer readable medium having instructions stored thereon, the instructions being executable by one or more processors to perform the operations described herein.

As multiple embodiments of the present disclosure have been elaborated above, it should be construed that they have been described by way of example alone, and not by way of limitation. Hence, the scope of the present disclosure should not be limited by any of the exemplary embodiments. Additionally, the present technology is defined above in terms of multiple exemplary embodiments and applications. It should be understood that the several features and the functionality explained in one or more of the distinct embodiments are not limited in their applicability to the specific embodiment with which they are explained, but instead can be functional, by itself or in a defined combination, to one or more of the other embodiments of the present technology, whether or not such embodiments are explained and whether or not such aspects are presented as being a part of a described embodiment.

What is claimed is:

1. A system for enabling dynamic filters for software search optimization comprising:
one or more processors and memory storing instructions that, when executed by the one or more processors, cause the one or more processors to perform operations comprising:
receiving a search request, user requirements, and the user preferences from the search system;
computing one or more filters from a list comprising a programming language filter, a software component license filter, a software component sources filter, a software component support provided filter, a software component type filter, an industry domain filter choices, and a software component security filter;
generating a filter widget based on the one or more computed filters; and
applying the filter widget crawling internet sources to provide search results.

2. The system of claim 1, the operations further comprising:
processing the search request, the filter requirements, and the user preferences from a search system;
associating the search request with different filter types to decide which filter templates to apply in addition to the filter requirements from the search system;
processing the user preferences from selection by the user or from past usage or from other users processing similar queries or a combination of all; and
determining a layout type and filter parameters for the filter widget, the layout type including one of a simple mode, an expanded mode, or a collapsed mode,
wherein the filter parameters include one or more of programming language, license, software sources, software component support, software component type, industries and domains, or security of the software component.

3. The system of claim 2, the operations further comprising:
receiving the layout type;
determining, based on the layout type, whether to include one or more filters in the filter widget; and
collating the filter parameters from the one or more filters in the requested filter layout format.

4. The system of claim 1, the operations further comprising:
providing, based on results of a machine learning algorithm, a predetermined number of the most relevant set of programming languages as filters related to the user search;
providing frameworks and technologies that are most relevant to the topic identified in the user search; and
sorting the most relevant set of programming languages based on the user preference or user behavior, according to the most frequently selected technologies by the user.

5. The system of claim 1, the operations further comprising:
providing, based on results of a machine learning algorithm, a predetermined number of the most relevant set of licenses as filters related to the user search;
processing one or more license types including open source, proprietary licenses, or cloud software; and
sorting based on the user preference or user behavior, according to the licenses that they most frequently select.

6. The system of claim 1, the operations further comprising:
providing, based on results of a machine learning algorithm, a predetermined number of the most relevant set of sources as filters related to the user search;
processing one or more sources including open-source repositories, proprietary software providers, or cloud providers; and
sorting based on the user preference or user behavior, according to the sources that they most frequently select.

7. The system of claim 1, the operations further comprising:
providing a gradient selection of support services provided by the relevant software component providers;
assigning weights to internal metrics including one or more of issue fix rate, number of bugs open, or reviews from the internet for selection of support level;
displaying a plurality of choices including high, medium, and low based on the weighted internal metrics; and
pre-selecting based on the user preference or user behavior, according to the support category that they most frequently select.

8. The system of claim 1, the operations further comprising:
providing, based on results of a machine learning algorithm, a predetermined number of the most relevant set of component types as filters related to the user search;
processing one or more component types including one or more of open-source repositories, proprietary software providers, or cloud providers; and
sorting based on the user preference or user behavior, according to the component types that they most frequently select.

9. The system of claim 1, the operations further comprising:
providing, based on results of a machine learning algorithm, a predetermined number of the most relevant set of domains and industries as filters related to the user search,
wherein the domains and industries include one or more of manufacturing, utilities, travel and transportation, retail, telecommunications and media, healthcare, financial services, government and institutions, artificial intelligence, blockchain, augmented reality, virtual reality, internet of things (IoT), big data, 3D printing, edge computing, robotics, autonomous navigation, biometrics, quantum computing, database, networking, security, messaging, DevOps, cloud computing, monitoring, serverless computing, integration, web servers, automation, testing, business process management (BPM), or data visualization; and
sorting based on the user preference or user behavior, according to the industries that they most frequently select.

10. The system of claim 1, the operations further comprising:
providing a gradient selection of security associated with the relevant software components;
assigning weights to internal metrics including one or more of vulnerabilities reported, number of bugs open, or reviews from the internet for selection of security level;
displaying choices including High, Medium, and Low, based on the user's internal metrics; and
pre-selecting based on the user preference or user behavior, according to the security category that they most frequently select.

11. The system of claim 1, the operations further comprising:
converting the one or more filters into a layout format,
wherein the format comprises messages including one or more of JSON, XML or fully usable UI components on a user device.

12. The system of claim 1, the operations further comprising:
accessing the internet sources including one or more of public repositories, cloud providers, Q&A, review sites, or vulnerability databases;
receiving information, based on the accessed internet sources, on programming language, licenses, sources, support, component types, industry domains and security information; and
parsing and storing received information into the File Storage.

13. A method of enabling dynamic filters for software search optimization comprising:
receiving a search request, user requirements, and the user preferences from the search system;
computing one or more filters from a list comprising a programming language filter, a software component license filter, a software component sources filter, a software component support provided filter, a software component type filter, an industry domain filter choices, and a software component security filter;
generating a filter widget based on the one or more computed filters; and
applying the filter widget crawling internet sources to provide search results.

14. The method of claim 13, further comprising:
associating the search request with different filter types to decide which filter templates to apply in addition to the filter requirements from the search system.

15. The method of claim 13, further comprising:
processing the user preferences from selection by the user or from past usage or from other users processing similar queries or a combination of all.

16. The method of claim 13, further comprising:
determining a layout type and filter parameters for the filter widget, the layout type including one of a simple mode, an expanded mode, or a collapsed mode,
wherein the filter parameters include one or more of programming language, license, software sources, software component support, software component type, industries, or security of the software component.

17. The method of claim 13, further comprising:
receiving the layout type; and
determining, based on the layout type, whether to include one or more filters in the filter widget.

18. The method of claim 13, further comprising:
providing, based on results of a machine learning algorithm, a predetermined number the most relevant set of programming languages as filters related to the user search including frameworks and technologies that are most relevant to the topic identified in the user search; and
sorting the most relevant set of programming languages based on the user preference or the user behavior, according to the technologies that the user most frequently selects.

19. The method of claim 13, further comprising:
providing, based on results of a machine learning algorithm, a predetermined number of the most relevant set of licenses as filters related to the user search including one or more of open source, proprietary licenses, or cloud software; and
sorting based on the user preference or the user behavior, according to the licenses that they most frequently select.

20. A computer program product for enabling dynamic filters for software search optimization comprising a processor and memory storing instructions thereon, wherein the instructions when executed by the processor cause the processor to perform operations comprising:
receiving a search request, user requirements, and the user preferences from the search system;
computing one or more filters from a list comprising a programming language filter, a software component license filter, a software component sources filter, a software component support provided filter, a software component type filter, an industry domain filter choices, and a software component security filter;
generating a filter widget based on the one or more computed filters; and
applying the filter widget crawling internet sources to provide search results.
